(19) United States
(12) Patent Application Publication
(10) Pub. No.: US 2002/0049711 A1
(43) Pub. Date: Apr. 25, 2002

(54) Method and system for accessing data in a database warehouse

(76) Inventor: Daniel M. Davenport, State College, PA (US)

Correspondence Address: Harold E. Meier, Baker Botts L.L.P., Suite 600, 2001 Ross Avenue, Dallas, TX, 75201, US

(21) Appl. No.: 09/850,541

(22) Filed: May 7, 2001

Related U.S. Application Data
(60) Provisional application No. 60/202,354, filed on May 5, 2000.

(51) Int. Cl. G06F 7/00

(52) U.S. Cl. 707/1

(57) ABSTRACT

A method comprises accessing data in a data warehouse having a hierarchical tree with a default successor and at least one non-default successor, where the non-default successors represent data information in databases of the data warehouse. A query comprising given information on data of interest is received and responded to with a response on the data of interest. When the given information comprises an instance of a default successor, the data of interest cannot be identified as available from the databases. When the given information has compatibility with more than one non-default successor, the data of interest may be available from the databases. When the given information has compatibility with one non-default successor, the data of interest has been identified as available from one non-default successor.

### BACKGROUND OF THE INVENTION

Many organizations must access information stored in numerous databases and in a variety of formats. The databases may be hosted on multiple machines, use different storage technologies, and include anything from duplicated to widely varying data. Unfortunately, methods for searching for information in multiple databases are often inefficient, particularly when a search is conducted with incomplete information. As a result, users have a difficult time finding information stored in multiple databases.

Data warehousing is an approach to navigating through multiple databases. A data warehouse is a database that accesses data from multiple databases. Access to the data warehouse is transparent to the user, who can readily retrieve and analyze information from the databases using the data warehouse. The data warehouse also includes information about how the warehouse is organized, where data is located, and relationships between data. The data warehouse may also allow an organization to organize its data, coordinate updates to data, and determine relationships between data gathered from different parts of the organization.

### SUMMARY OF THE INVENTION

While known approaches have provided improvements over prior approaches, the challenges in the field of database systems have continued to increase with demands for more and better techniques having greater effectiveness. Therefore, a need has arisen for a new method and system for organizing and accessing data in a database warehouse.

According to one embodiment of the present invention, a method for accessing data in a data warehouse having a hierarchical tree with a default successor and a non-default successor is disclosed. The successors represent data information in databases of the data warehouse. A query comprising given information on data of interest is received. The query is responded to with a response on the data of interest. When the given information comprises an instance of a default successor, the data of interest cannot be identified as available from the databases. When the given information has compatibility with more than one non-default successor, the data of interest may be available from one or more of the databases. When the given information has compatibility with one non-default successor, the data of interest has been identified as available from one non-default successor.

According to one embodiment of the present invention, a system for accessing data in a data warehouse is disclosed. A hierarchical tree has a default successor and at least one non-default successor. The successors represent information in databases of a data warehouse. An input receives a query comprising given information on data of interest. A processor responds to the query with a response on the data of interest. When the given information comprises an instance of a default successor, the data of interest cannot be identified as available from the databases. When the given information has compatibility with more than one non-default successor, the data of interest may be available from one or more of the databases. When the given information has compatibility with one non-default successor, the data of interest has been identified as available from the compatible non-default successor.

Technical advantages may be exhibited by one or more embodiments of the present invention. A technical advantage of one embodiment is that efficient querying of multiple databases is provided. A hierarchical tree is formulated to model relationships among the data in different databases. A data warehouse uses the tree to efficiently search the databases. Another technical advantage of one embodiment is that a user may search the data warehouse using a query with incomplete information. The data warehouse outputs an answer, a limited answer, or no answer.

Other technical advantages are readily apparent to one skilled in the art from the following figures, descriptions, and claims.

### BRIEF DESCRIPTION OF THE DRAWINGS

A more complete understanding of the present invention may be had by reference to the following detailed description when taken in conjunction with the accompanying drawings wherein:

FIG. 1 illustrates one embodiment of a system for accessing data in a database warehouse in accordance with the present invention;

FIG. 2 illustrates one embodiment of a hierarchical tree in accordance with the present invention;

FIG. 3 illustrates one embodiment of a node in accordance with the present invention; and

FIG. 4 is a flow chart illustrating one embodiment of a method for accessing data in a database warehouse in accordance with the present invention.

### DETAILED DESCRIPTION OF THE DRAWINGS

An embodiment of the present invention and its advantages are best understood by referring to FIGS. 1 through 4 of the drawings, like numerals being used for like and corresponding parts of the various drawings.

FIG. 1 illustrates one embodiment of a system for accessing data in a data warehouse in accordance with the present invention. In this embodiment, the system includes a data warehouse 110 that enables access to information from one or more databases 112 using a database server 111. Databases 112 may be distributed over several computers in different locations, and include information from multiple sources in a variety of formats. Databases 112 include relational databases that store information in tables and enable conducting searches by using data in one table to find data in another table. Database server 111 includes a network station that stores data and provides access to databases 112.

A user making a search of the databases 112 uses a processor 114 to access data warehouse 110. Processor 114 includes any suitable computing system that communicates with data warehouse 110. While one processor 114 is used to illustrate access to data warehouse 110, functionality of processor 114 may be divided or combined over any number of processing systems. An input device 116, for example, a keyboard, a mouse, or a voice recognition system, is used to communicate with the processor 114. An output from data warehouse 110 is displayed on a monitor 118, printed on a printer 120, stored in a storage device 122, or output to some other suitable output device. Storage device 122 includes, for example, a magnetic or optical storage device, such as used with a floppy drive, hard drive, removable hard drive, optical drive, or CD ROM drive.

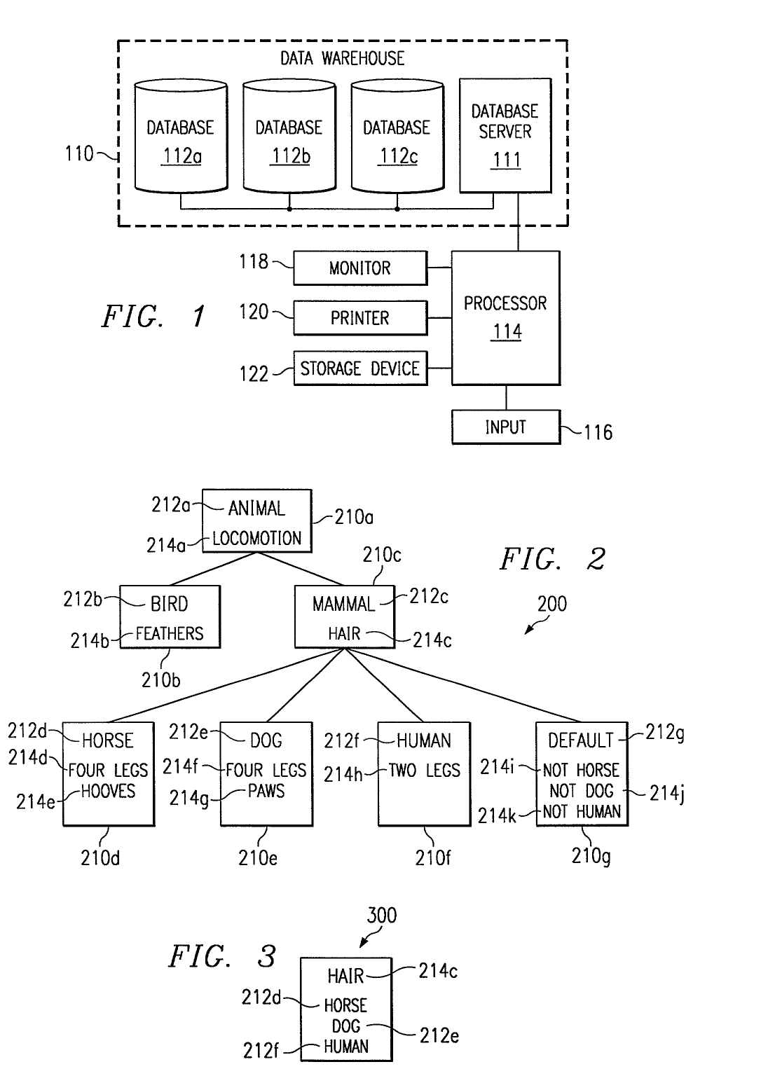

Referring to FIG. 2, there is illustrated a hierarchical tree 200 of nodes 210 in accordance with one embodiment of the present invention. Tree 200 models the relationships among data in databases 112. Node 210a is a root node and a predecessor of nodes 210b and 210c. Conversely, nodes 210b and 210c are successors nodes of node 210a. A successor of a predecessor may be viewed as a subset or subclass of the predecessor. Node 210b is a terminating node because it has no successors, and node 210c is a non-terminating node because it has successors. Node 210c is a predecessor of nodes 210d-g. Since nodes 210d-g have no successors, they are terminating nodes. Nodes 210 include objects 212 that represent information from databases 112. Nodes 210 of tree 200 include type objects 212, for example, node 210a includes an animal type object 212a. Each type object 212 is associated with attribute objects 214, for example, animal type object 212a is associated with a locomotion attribute object 214a. An attribute object 214 may be associated with type objects 212, as discussed in connection with FIG. 3. Type objects 212 and attribute objects 214 describe information represented by the node. For example, node 210a represents that “an animal has locomotion.”

FIG. 3 illustrates a node 300 that includes a hair attribute object 214c. Hair attribute object 214c is associated with a horse type object 212d, a dog type object 212e, and a human type object 212f. Node 300 represents that “a horse, a dog, and a human have hair.”

Referring back to FIG. 2, given a node v, then v* is the information that node v represents. In one embodiment, the information at any two distinct nodes may not be identical. If u is a successor of v, then the conjunction of u* and v* is equivalent to u*. That is, u represents at least the information represented by v and some more as well. For example, node 210d represents that “a horse has hair”, which is the information that node 210c represents, and also represents that “a horse has four legs and hooves.”

Given a non-terminating node v, then d(v) is a default successor node of v, and s(v) is a non-default successor node of v. Every non-terminating node has a unique default successor node and one or more non-default successor nodes. Non-default successor nodes s(v) represent known subsets of node v. For example, non-default successor nodes 210d, 210e, and 210f of node 210c represent horses, dogs, and humans, which are known subsets of mammals. Default successor node d(v) represents unknown or unfamiliar successors of node v. For example, default successor node 210g represents that “an animal that is not a horse, not a dog, or not a human.” Specifically, the information that a default successor d(v) represents is the conjunction the information at v and the negation of the information represented by the non-default successor nodes s(v). That is, the information represented by the default successor node d(v) is the complement of the information at the non-default successor nodes s(v) relative to the information at v.

Information x is an instance of a node v if x conjoined with v* is equivalent to x. For example, “Spot is a mammal and has hair” conjoined with “a mammal has hair” represented by node 210c, is equivalent to “Spot is a mammal and has hair.” An instance of a node may be viewed as an element or member of the node. Information x is compatible with v if x conjoined with v* is not false. For example, “Spot is a mammal and is brown” conjoined with “a mammal has hair” is not false. If x is an instance of v, then one of the following three cases holds:

1) x is not compatible with any non-default successors s(v), that is, x is an instance of the default successor d(v). For example, “Spot is a mammal that is not a horse, not a dog, and not a human” is an element of “an animal that is not a horse, not a dog, and not a human.”

2) x is compatible with more than one non-default successors s(v). For example, “Spot has four legs” is compatible with “a horse has four legs” and “a dog has four legs.”

3) x is compatible with exactly one non-default successor s(v). For example, “Spot has four legs and paws” is compatible with only “a dog has four legs and paws.”

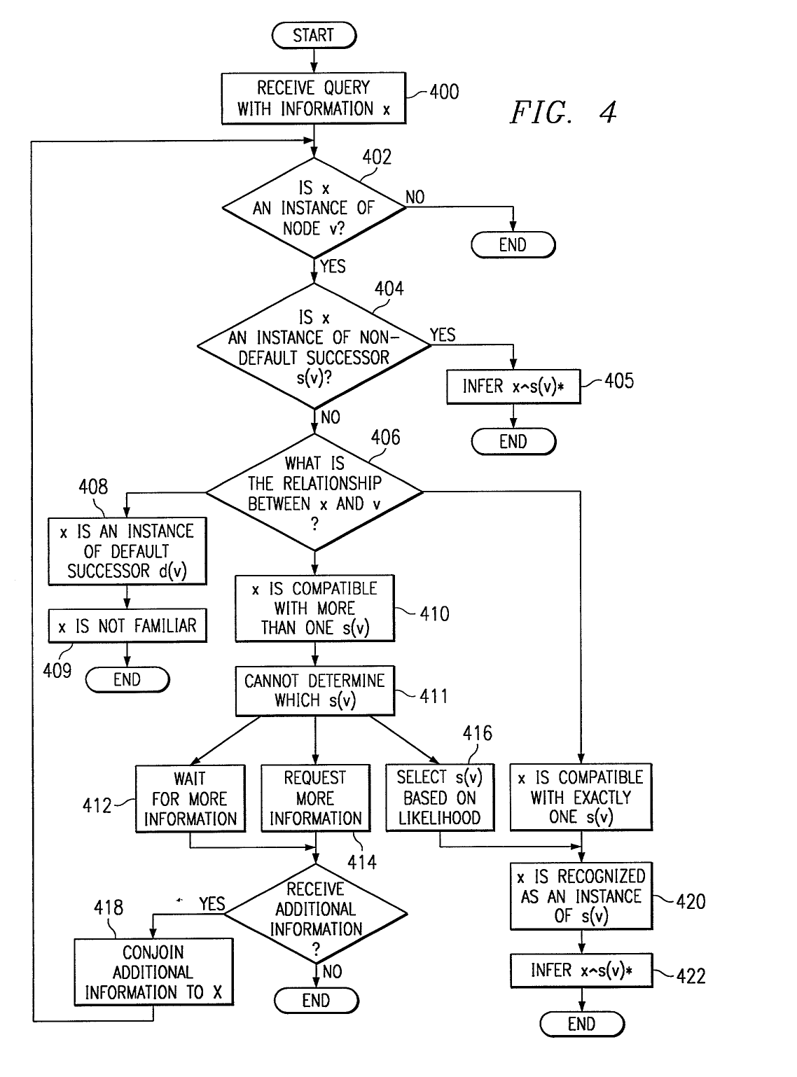

FIG. 4 is a flowchart illustrating a method for conducting a search according to one embodiment of the present invention. The method begins at receive query 400, where a data warehouse 110 receives a user query. The query asks for information about an entity named “Spot,” and includes a given amount of information x about Spot. For example, x includes a description of Spot such as “Spot has hair.” At evaluation 402, the process run by data warehouse 110 determines whether x is an instance of any node 210 of tree 200. If x is not an instance of any node 210, the method terminates.

If x is an instance of node v, for example, node 210c, the method proceeds to an evaluation 404, where the process run by data warehouse 110 determines whether x is an instance of a non-default a successor node s(v) of node v. If x is an instance of a successor node s(v), then at inference 405 the process of data warehouse 110 infers the conjunction of x and s(v)*, the information represented by successor node s(v). For example, if x is an instance of node 210e, the process of data warehouse 110 infers that “Spot has four legs and paws.” That is, data warehouse 110 merely confirms the user query. After inferring the conjunction, the method terminates.

If x is not an instance of any non-default successor s(v), the method proceeds to an evaluation 406, where a determination is made by evaluating the relationship between x and node v. If x is not compatible with any non-default successor s(v), that is, x is an instance of the default successor d(v), then the method proceeds to a determination 408. At step 409, the process of data warehouse 110 responds to the query with an answer that x is an instance of v, but does not belong to any known successor of v, that is, “x is not familiar.” That is, data warehouse 110 does not provide additional information in response to the user query. After the determination is made, the method terminates.

If x is determined to be compatible with more than one non-default successors s(v) at evaluation 406, then the method proceeds to determination 410. At step 411, data warehouse 110 determines that x is an instance of some successor s(v), but cannot determine which successor. The process run by data warehouse 110 may wait for additional information at wait 412, for example, “Spot has hooves” or “Spot has paws,” to make a decision. Alternatively, data warehouse 110 may request more information concerning Spot at request 414. For example, data warehouse 110 asks a user to identify what kind of feet Spot has. If the process of data warehouse 110 does not receive additional information at wait 412 or in response to request 414, the method terminates. If at wait 412 or request 414 data warehouse 110 receives more information, the method proceeds to conjoin 418, where data warehouse 110 conjoins the additional information with information x. The method returns to evaluation 402, where the method of data warehouse 110 determines whether x is an instance of node v.

Alternatively, the method selects a successor s(v) according to a likelihood rule at selection 416. For example, data warehouse 110 includes a rule that states “If Spot has four legs, there is an 82% chance that Spot is a dog, and an 18% chance that Spot is a horse.” According to the rule, data warehouse 110 determines that x is recognized as an instance of the most likely successor s(v), that is, “Spot is a dog” at recognition 420. The process of data warehouse 110 conjoins x to s(v)* and infers their conjunction at inference 422, for example, “Spot is a mammal and is a dog,” which is output as an answer to the query. That is, anything known about being an instance of s(v) becomes a part of what is known about x. After inferring the conjunction, the method terminates.

If x is compatible with exactly one non-default successor s(v) at evaluation 406, then the method proceeds to recognition 420, where data warehouse 110 determines that x is recognized as an instance of s(v). At inference 422, data warehouse 110 infers the conjunction of x and s(v)*, which is output as an answer to the query. That is, data warehouse 110 provides additional information in response to the user query. After inference 422, the method terminates.

While the invention has been described in connection with a preferred embodiment, it is not intended to limit the scope of the invention to the particular form set forth, but, on the contrary, it is intended to cover alternatives, modifications, equivalents as may be included within the spirit and scope of the invention as defined in the appended claims.

What is claimed is:

1. A method for accessing data in a data warehouse having a hierarchical tree comprising a default successor and at least one non-default successor, the successors representing data information in a plurality of databases of the data warehouse, comprising:
receiving a query comprising given information on data of interest; and
responding to the query with a response on the data of interest that:
the data of interest cannot be identified as available from the databases when the given information comprises an instance of a default successor;
the data of interest may be available from the databases when the given information has compatibility with more than one non-default successor; and
the data of interest has been identified as available from one non-default successor when the given information has compatibility with one non-default successor.

2. The method for accessing data in a data warehouse as set forth in claim 1, further comprising determining whether the given information comprises an instance of a predecessor of the successors.

3. The method for accessing data in a data warehouse as set forth in claim 1, further comprising determining whether the given information comprises an instance of one non-default successor.

4. The method for accessing data in a data warehouse as set forth in claim 3, further comprising outputting a response resulting from the conjoining of the given information with the information represented by the non-default successor.

5. The method for accessing data in a data warehouse as set forth in claim 1, further comprising outputting a response resulting from the conjoining of the given information with the information represented by the non-default successor when the given information has compatibility with one non-default successor.

6. The method for accessing data in a data warehouse as set forth in claim 1, further comprising requesting additional information when the given information has compatibility with more than one non-default successor.

7. The method for accessing data in a data warehouse as set forth in claim 6, further comprising:
adding the additional information to the query; and
repeating responding to the query with a response on the data of interest that:
the data of interest cannot be identified as available from the databases when the given information comprises an instance of the default successor;
the data of interest may be available from the databases when the given information has compatibility with more than one non-default successor; and
the data of interest has been identified as available from one non-default successor when the given information has compatibility with one non-default successor; and
requesting additional information when the given information has compatibility with more than one non-default successor until the given information comprises an instance of the default successor or has compatibility with one non-default successor.

8. The method for accessing data in a data warehouse as set forth in claim 1, further comprising selecting a non-default successor according to a likelihood that the given information has compatibility with the non-default successor.

9. The method for accessing data in a data warehouse as set forth in claim 1, wherein the given information describes a data entity, and a non-default successor describes the data entity when the given information has compatibility with the non-default successor.

10. A system for accessing data in a data warehouse, comprising:
a hierarchical tree comprising a default successor and at least one non-default successor, the successors representing information in a plurality of databases of a data warehouse;
an input receiving a query comprising given information on data of interest; and
a processor for responding to the query with a response on the data of interest that:
the data of interest cannot be identified as available from the databases when the given information comprises an instance of a default successor;
the data of interest may be available from the databases when the given information has compatibility with more than one non-default successor; and
the data of interest has been identified as available from one non-default successor when the given information has compatibility with one non-default successor.

11. The system for accessing data in a data warehouse as set forth in claim 10, further comprising a predecessor of the successors, wherein the processor determines whether the given information comprises an instance of the predecessor.

12. The system for accessing data in a data warehouse as set forth in claim 10, wherein the processor further determines whether the given information comprises an instance of one non-default successor.

13. The system for accessing data in a data warehouse as set forth in claim 12, wherein the processor further outputs a response resulting from the conjoining of the given information with the information represented by the non-default successor.

14. The system for accessing data in a data warehouse as set forth in claim 10, wherein the processor further outputs a response resulting from the conjoining of the given information with the information represented by a non-default successor when the given information has compatibility with one non-default successor.

15. The system for accessing data in a data warehouse as set forth in claim 10, wherein the processor further requests additional information when the given information has compatibility with more than one non-default successor.

16. The system for accessing data in a data warehouse as set forth in claim 15, wherein the processor further responds to the query by:
adding additional information to the query; and
repeating responding to the query with a response on the data of interest that:
the data of interest cannot be identified as available from the databases when the given information comprises an instance of a default successor;
the data of interest may be available from the databases when the given information has compatibility with more than one non-default successor; and
the data of interest has been identified as available from one non-default successor when the given information has compatibility with one non-default successor; and
requesting additional information when the given information has compatibility with more than one non-default successor until the given information comprises an instance of the default successor or has compatibility with one non-default successor.

17. The system for accessing data in a data warehouse as set forth in claim 10, further comprising the processor selects a non-default successor according to a likelihood that the given information has compatibility with the non-default successor.

18. The system for accessing data in a data warehouse as set forth in claim 10, wherein the given information describes a data entity, and a non-default successor describes the data entity when the given information has compatibility with the non-default successor.
